(19) United States
(12) Patent Application Publication
(10) Pub. No.: US 2015/0058145 A1
(43) Pub. Date: Feb. 26, 2015

(54) Universal check-out system for Mobile Payment Applications/Platforms

(71) Applicant: Sergio Luciani, Sarasota, FL (US)

(72) Inventor: Sergio Luciani, Sarasota, FL (US)

(21) Appl. No.: 14/292,543

(22) Filed: May 30, 2014

Related U.S. Application Data
(60) Provisional application No. 61/964,518, filed on Jan. 7, 2014.
(60) Provisional application No. 61/855,209, filed on May 10, 2013.

(51) Int. Cl. G06Q 20/20; G06Q 20/32

(52) U.S. Cl. CPC G06Q 20/204; G06Q 20/3274
USPC 705/17

(57) ABSTRACT

A hardware/software architecture and process methodology are disclosed by which mobile payment platforms are enabled in an existing payment processor's merchant base at their point of sale system (“POS”) without the necessity of implementing new hardware or software at the merchant level and for each of said merchant's POS system.

### BACKGROUND OF THE INVENTION

### Current State of the Art

Today, almost all merchants, whether brick and mortar or e-commerce (online-based) businesses, accept electronic payments (e.g., credit cards, debit cards, gift cards, in addition to private payment solutions such as PayPal® and Google Wallet®) as tender for transactions. The emergence of smart phones contributed to the development of mobile payment solutions which now account for a significant portion of e-commerce, and are poised to become a large if not preponderant portion of the electronic payments ecosystem. Electronic payments are also accepted by increasing numbers of vending machines, kiosks, automated tellers and other systems without a human merchant needed to conduct the transaction or to process payment as tender for the transaction. The underlying system that allows merchants to accept payment for, clear these transactions and receive the appropriate credit and acknowledgment, while providing the customer with the necessary link to their credit/debit solutions, consists of an architecture involving at least some of the following parties and components, defined as follows:
Acquiring Bank: The Acquiring Bank holds the contract for providing payment processing services to the merchant. The merchant account is a contract under which the Acquiring Bank extends a line of credit to a merchant who wishes to accept credit card transactions. The Acquiring Bank holds all the risk on every transaction as well as the operation of every registered acquiring ISO/MSP and their sub-agents and are responsible for all Association fines.
Association: The consumer payment system whose members are the financial institutions that issue payment cards and/or sign merchant to accept payment cards.
Back-End Network: The platform that takes captured transactions from the Front-End Network and settles them through the Interchange system. The back-end generates daily ACH files for merchant settlement. Other functions typically handed on the back-end include chargeback handling, retrieval request and monthly statements. Usually provided by the Processor or Acquiring/Issuing Bank and/or their third party agents.
BIN-IIN: A number used to identify the issuer. Part of a payment card number, typically the first six digits of a payment card number assigned to a bank that issues payment cards (e.g. credit cards). BIN-IIN services allow an issuing bank to receive requests for settlement of transaction involving the “issued card” via the Interchange back to the merchant.
Cardholder: Authorized user of a payment card (e.g. credit, debit, or gift card). See also, Customer.
Closed-loop card solution: A card recognized by the front end gateway of a processor as a financial instrument whose clearance process should be routed outside of the Interchange system.
Customer: Individual having a mobile payment application downloaded on his/her mobile device (which typically is a mobile phone, smart phone, or tablet computer). Also called Mobile Application User.
Front-end Network: The platform that the credit card terminal/gateway communicates with when approving a transaction. The front-end is responsible for the authorization and capture portion of a credit card transaction. Additional front-end platform interconnections may be required to suppor ACH and debit transaction. Usually provided by the acquiring bank, processor, or processor's approved/certified third party.
Independent Sales Organization (ISO)/Member Services Provider (MSP) (“Processor”): Entity that solicits merchants on behalf of an Acquiring Bank for payment card acceptance and enables card payments from customers. Acquirer's generally hold responsibility for providing customer service, merchant-level support, merchant-level compliance with Association rules and underwriting of merchant accounts. Sometimes called Processor.
Interchange: The process and communication network, by which all parties involved in a credit card transaction (i.e., processors, acquirer, issuers, etc.) manage the processing, clearing and settlement of credit card transactions, including the assessment and collection and/or distribution of fees between all parties.
Issuing Bank: A financial institution that issues payment cards and maintains a contract with cardholders for repayment.
Merchant: Authorized acceptor of payment cards for the payment of goods and services provided to customer.
Mobile Payment Platforms/Solutions (“MPS”): A software/hardware based system that enables mobile devices such as telephones to communicate with parties involved in a credit or debit tranaction and providing the means by which credit data pertinent to the owner of the device is transmitted to some of the parties involved to settle a transaction. The Platform can perform processing functions directly to an acquiring bank or can be integrated with one or more processor to perform clearing functions.
Payment Gateway : The virtual device (software) used by the merchant to communicate information to the Acquirer's Front-End Network. The Gateway is certified as PCI compliant and can collect or retrieve credit data information from a “Vault” to be forwarded along with the total amount due to the issuing bank of the credit instrument for approval of the transaction. It is the means by which a physical point of sale terminal, located at a merchant's retail outlet, comunicates and settles credit/debit transactions. Payment gateways interface with a merchant's POS system and pass that data to a Front-End Authorization Network. Usually provided by Acquiring Bank, Processor or processor's agent (ISO) or third party integrated with processor/Acquiring Bank.
POS/Terminal: The physical or virtual device used by the merchant to communicate information to the Acquirer's Front-End Network. Usually provided by acquiring bank, processor, or processor's agent (ISO) or third party integrated with processor/Acquiring Bank.
Financial Instrument/Card: A traditional magnetic stipe card recognizable by the BIN-IIN management system or by the issuing bank as a special card whose requests will be redirected to the “Server.” The card contains information relative to the merchant and the Terminal ID Vault System: software environment where processors store sensitive data such as credit and personal data to be used for many purposes including applications by a third party which can use such data as related to their application without need to actually have direct access.
The Server: A computing device receiving and sending information from the BIN-IIN management system. A closed-loop card solution or the issuing bank regarding activing (swipes) realtive to the financial instrument/card. The information includes transaction amount and merchant and terminal data. The server receives and sends information form all Mobile Payment Platforms attempting to clear a transaction from a merchant's POS and comunicates back to the MPS.
Virtual Terminal: Processor's administrative system which gives access to merchant of all activity occurring in merchant settlement of credit-debit transactions.

### Brief Background on Current State of the Art of Traditional Credit Card Transaction Processing

Currently when a merchant and a processor execute an agreement so that the processor will handle the merchant's electronic payment transactions, the processor creates a merchant account for the merchant that identifies the merchant and defines the parameters related to that agreement. Such agreement defines the types of transactions that the merchant is authorized to undertake and includes merchant ID, processor ID and a merchant account ID. This data is stored in a secure environment usually identified as Payment Card Industry (“PCI”) compliant. Once the payment interface unit is configured so that communication with the processor occurs within the required parameters, including a merchant profile and identification of the specific point of sale (“POS” or “Terminal”) unit, this allows for identification of the parameters related to the merchant agreement with the processor and of the specific POS terminal unit involved in the transaction. The payment interface unit will create a transaction request based on the customer profile (or “customer ID”), the processor application, the merchant profile (or “merchant ID”), the specific POS Terminal ID, and the total payment amount due. Accordingly, third party vendors are utilized to install and configure the payment interface units at the merchant POS Terminal sites, so that they address the processor's application requirements and enabling communications channels between the specific merchant and specific processor. Within this framework, credit-debit processing of transactions between consumer and merchant (C to B) or between merchants (B to B) are undertaken with either (a) card-present status (where the actual card having a magnetic stripe is swiped on a magnetic card reader, said magnetic stripe containing two encoded tracks of information about the card, the cardholder and the issuing financial institution), or (b) card-not-present status (where card information is conveyed orally/manually via a telephone a fax or other media input). E-commerce transactions in general qualify as card not present status as the data is manually entered into the merchant system remotely, with various systems integrated to address and minimize the likelihood of fraud.

### Brief Background on Current State of the Art of Credit Card Processing Using Mobile Device Solutions

The emergence of mobile e-commerce and the prevalent use of mobile devices (such as smart phones and tablets) by the general public has brought a new dimension to credit card transactions with the adoption of mobile payment platforms, where consumers make use of their mobile devices and enabled wireless internet connections to a payment clearing environment (Mobile Payment Platform/System (“MPS”)) to pay for goods or services using their mobile device. The transaction is initiated by the consumer via a mobile payment application resident on the consumer/customer's mobile device which communicates to the MPS, which in turn transmits to the processor the relevant total due for the transaction, the merchant ID, and consumer's credit card information stored on the mobile device. While this new functionality is expected to eventually take a large if not dominant share of the credit/debit transaction ecosystem, it is still limited by the fact that each mobile application residing on a mobile device, and it's corresponding MPS, in order to communicate the information necessary to clear a credit/debit transaction, needs to be integrated with the specific processor company used by the merchant and in addition with the merchant's POS system. While there is a limited amount of processors, the number of software POS systems and hardware providers is so large and diverse that ensuring functionality under all these platforms by a MPS and its Mobile Payment Application is a near impossibility due to the expense involved in ensuring compatibility. This process is being addressed in a number of different ways aimed at minimizing the need for integration at the merchant level, but still relys on the necessity for each merchant to integrate in some form with these existing solutions, such as by adding additional integrating hardware to the merchant's existing POS hardware. This integration obstacle is the major problem with the present state of the art in mobile payment systems for which the present invention presents a solution.

### SUMMARY OF THE INVENTION

The present invention generally relates to the field of e-commerce and mobile payments for consumer transactions at the point of sale. Mobile payments are by definition the process by which payment for a service is undertaken by a customer via a telephone (hence the mobility definition). Ordinarily enabling such payment solution requires that the POS terminal system be modified to accommodate and integrate the mobile payment platform with the merchant's existing POS system (comprised of one or more POS terminals i.e. cash registers). Given the diverse and non-homogeneous nature of these systems (that range from complex server or PC-based solutions to basic magnetic card reader units) and the different architectures involving POS software and actual cash registers, it is currently impossible to implement mobile payment solutions over a large number of merchants without individual set up and integration. This process precludes mobile solutions from enabling a large number of merchants economically and in a short period of time.

The present invention proposes to introduce novel and unique architecture and process methodology, making use of existing industry components, whereby a mechanism is implemented, by which single or multiple mobile payment platforms can be enabled in an existing processor's merchant base and each merchant's POS terminal or via a magnetic card reader connected to the POS Terminal, without the necessity of implementing expensive integration solutions at the merchant level. By the use of this novel process and architecture, payment of a total due at checkout at a merchant is made possible via the customer's use of a mobile payment application residing in that customer's mobile device (smart phone, tablet, etc.) communicating to a MPS that communicates with the merchan'ts payment processor. Transaction results (e.g. payment confirmation or denial) are received and acknowledged by the POS Terminal system and by the customer's Mobile Payment Application.

### BRIEF DESCRIPTION OF THE DRAWINGS

FIG. 1. shows a schematic view of a fully integrated mobile payment system consistent with a first and second preferred embodiments of the invention, without any additional hardware integration, herein disclosed by the present invention.

FIG. 2. shows a schematic view of a fully integrated mobile payment system consistent with a third and fourth preferred embodiments of the invention, said mobile payment system having an additional device connected to the merchant's POS system, herein disclosed by the present invention.

FIG. 3. shows a schematic view of a general flow of data during a mobile payment transaction.

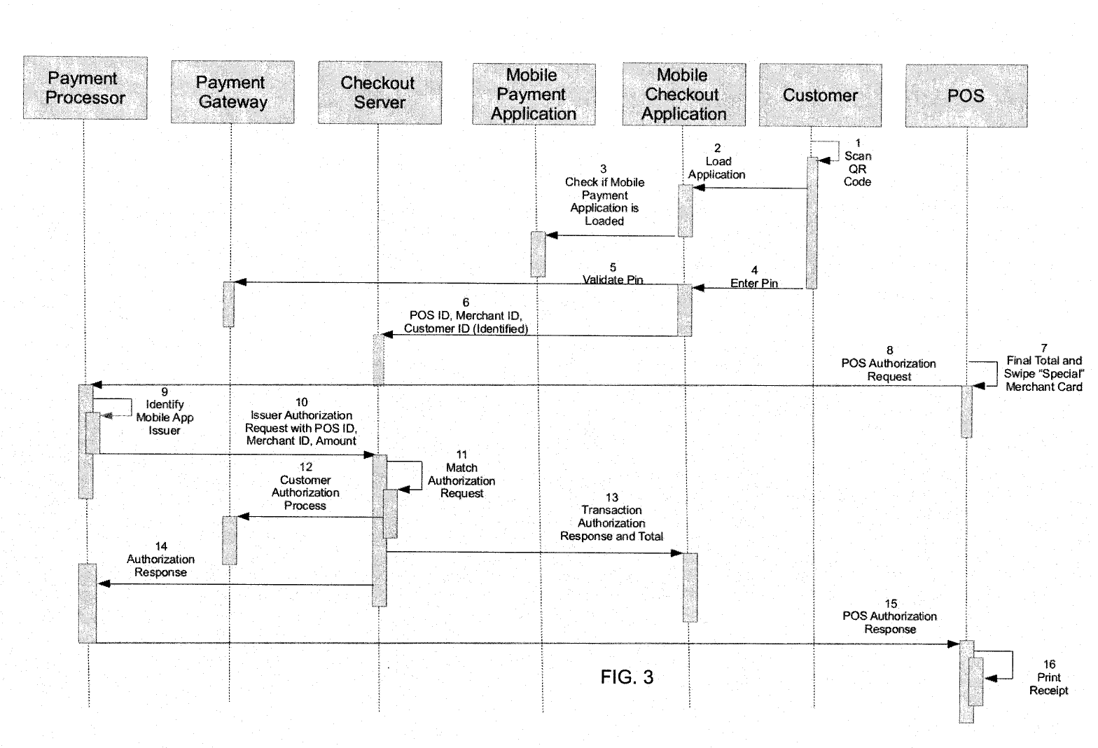

FIG. 4. shows a schematic view of a general closed-loop solution herein described.

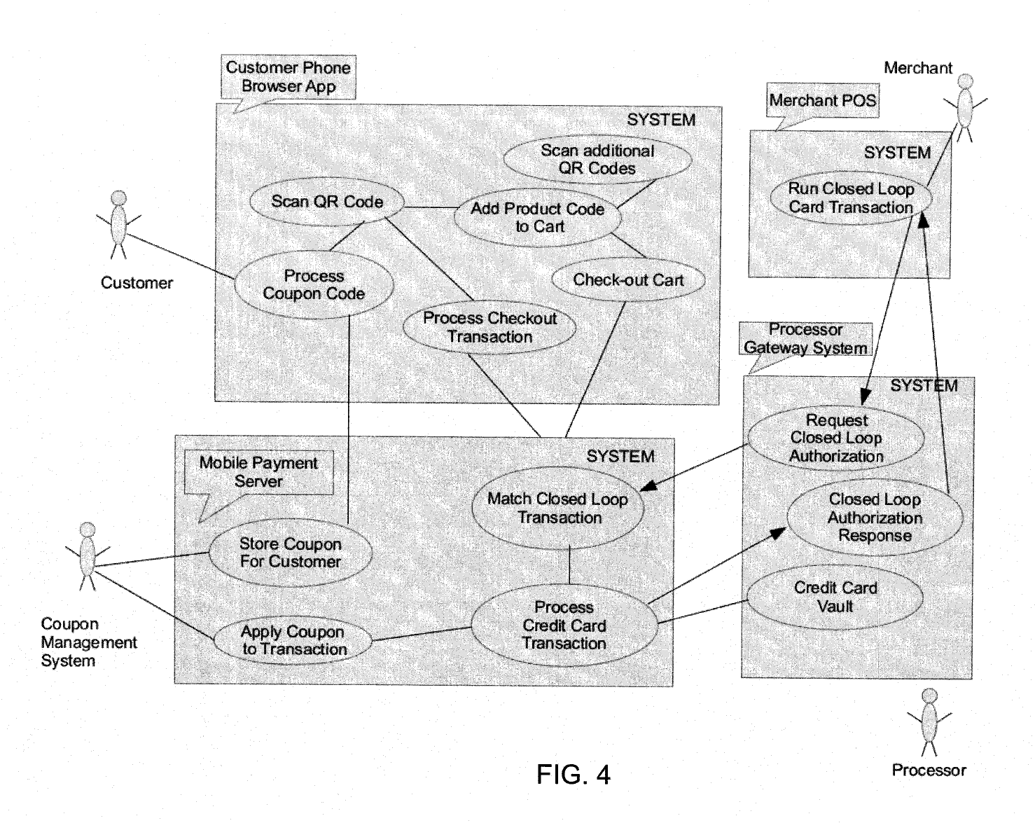

FIG. 5. shows a schematic view of a general open-loop solution herein described.

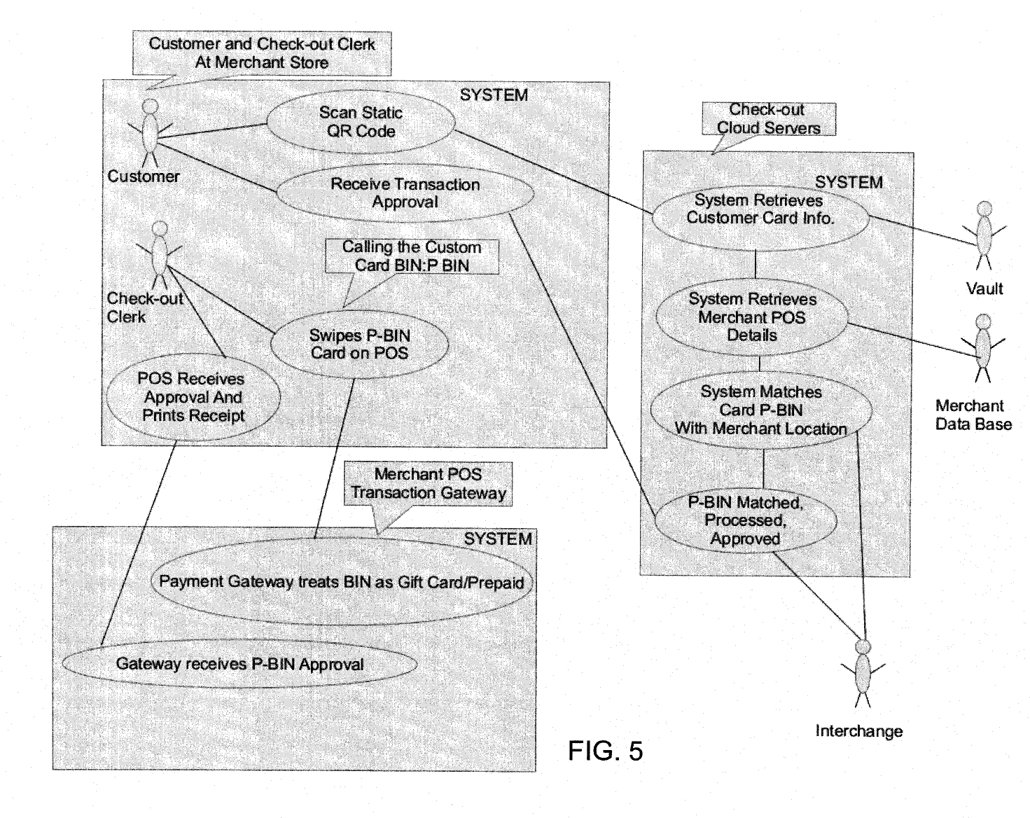

### DESCRIPTION OF THE VARIOUS EMBODIMENTS OF THE INVENTION

To achieve the foregoing utility in accordance with the purpose of the invention, a preferred embodiment of a process and architecture are described.

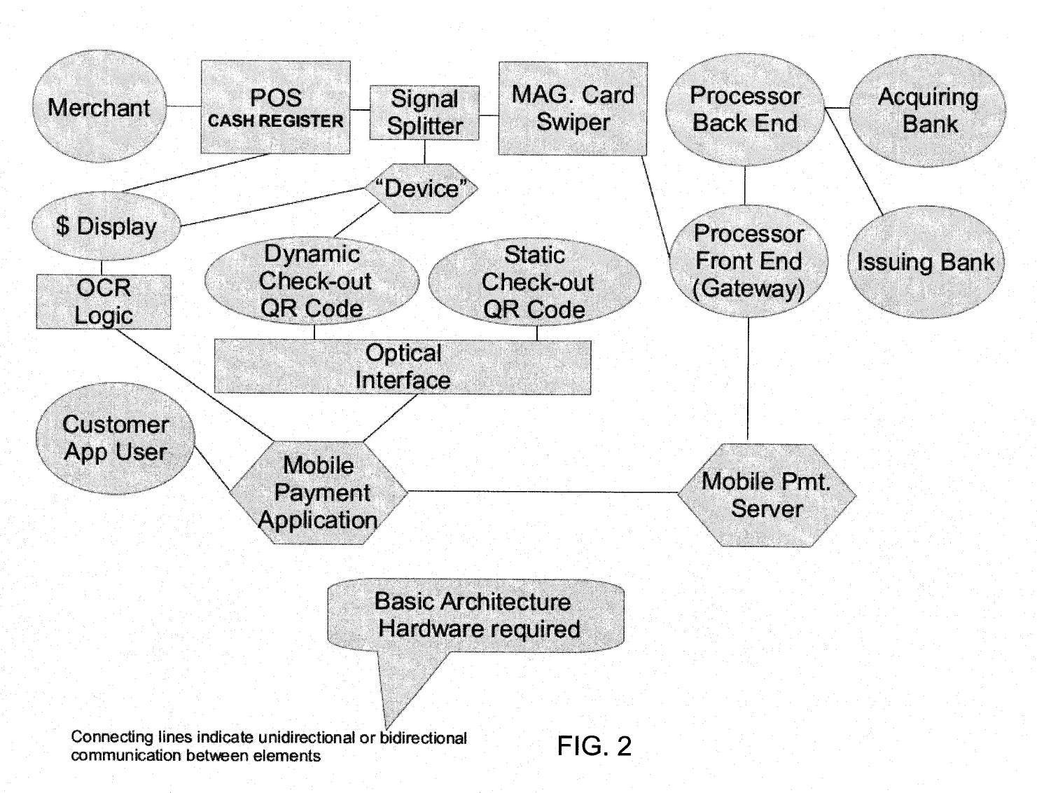

FIG. 2. shows a process and architecture for mobile payments between a customer and a merchant without the need to integrate additional hardware with the merchant's POS terminal system. In this embodiment of the invention, a merchant having a POS Terminal system (e.g. cash register), either having a built-in magnetic card reader (“card swiper”) or being connected to a magnetic card swiper such as Veriphone® model VX510 or Ingenico® model ICT-220 via RS232 or similar connection means known in the art, displays a total amount due received from the terminal. The card swiper is connected to the internet and has basic browser and communication functions with the merchant's payment processor via that processor's payment gateway. Once the total due is received from the POS, the card swiper is ready to receive data from its magnetic scanner. The customer, possessing a mobile device with capabilities of GPS location identification, radio and near-frequency communication capabilities, mobile data/internet functionality, and optical scanning capabilities, and having a mobile payment application designed to utilize one or more of these functions, scans a static matrix/QR code (“QR code”) displayed near the POS via the mobile device's payment application and is taken to a mobile payment server (MPS). This QR code can be printed on any suitable media (e.g. paper, transparency, laminate, sticker) and placed where visible to the customer using the Mobile Payment Application. Multiple QR codes may be displayed at once, each addressing a different payment platform depending on the customer's preference provided that each individual payment platform could communicate with the device either directly or via a unique MPS integration. Each QR code contains data identifying the merchant ID, POS Terminal ID, and merchant processor information. The mobile payment application transmits these three pieces of data, along with the customer's information and customer's financial instrument information, which are stored or entered on the mobile device, to the MPS. The MPS receives this information, and retrieves customer ID and customer's financial instrument (e.g. credit card information from a PIC-compliant environment and sends a request to the processor that includes customer's credit card information, customer ID, merchant ID, and POS ID. The merchant's card swiper, being set to wait for input by the POS Terminal, receives data by the merchant then swiping a merchant magnetic card (“Merchant Card”) containing data that enables the card swiper to transmit to processor as if receiving the customer's card. The Merchant Card contains a set of data that can be either (A) a closed-loop solution, acting as a flag to the processor and instructing the processor's payment gateway to route the request to settle the transaction to the MPS server in a similar manner to a gift card solution or other closed-loop solution implemented by the processor's payment gateway, whereby the processor's payment gateway software has been modified to recognize a specific data range to acts as a redirect of the settlement process internally; or (B) as an open-loop solution, acting as a normal credit card transaction, whereby the MPS has been previously assigned a BIN number or data range recognized by the Interchange and acts effectively as an Issuing Bank. The MPS receives the Merchant ID, POS Terminal ID, customer ID and customer's financial instrument information from the mobile payment application when the customer optically scans the merchant's matrix/QR code, and also receives the Merchant ID, POS Terminal ID, and the total amount due from the processor's payment gateway as a request for settlement of the transaction. The MPS compares these two flows of data, verifies the information is the same, and forwards this data to the processor to settle the transaction. The processor completes the transaction, and sends notification of transaction results to the POS Terminal. The POS and/or card swiper may print a receipt and acknowledgment of payment. The MPS sends acknowledgment of payment to the customer's mobile payment application.

A process and architecture for a second preferred embodiment of the present invention is also shown in FIG. 2 whereby the customer in addition to scanning a matrix/QR code, uses the camera feature of the customer's mobile device to take a picture of the total due from a display monitor (dot matrix, LCD, LED, or similar display monitor) connected to the merchant's POS Terminal. The mobile payment application sends the picture to the MPS. The MPS server uses OCR software to decode the total amount due from the customer's picture. The MPS also matches the merchant ID, POS Terminal ID obtained from the scanned QR code, and transmits all of this data to the processor to settle the transaction. The remaining steps of the transaction are completed in the same manner as the first preferred embodiment.

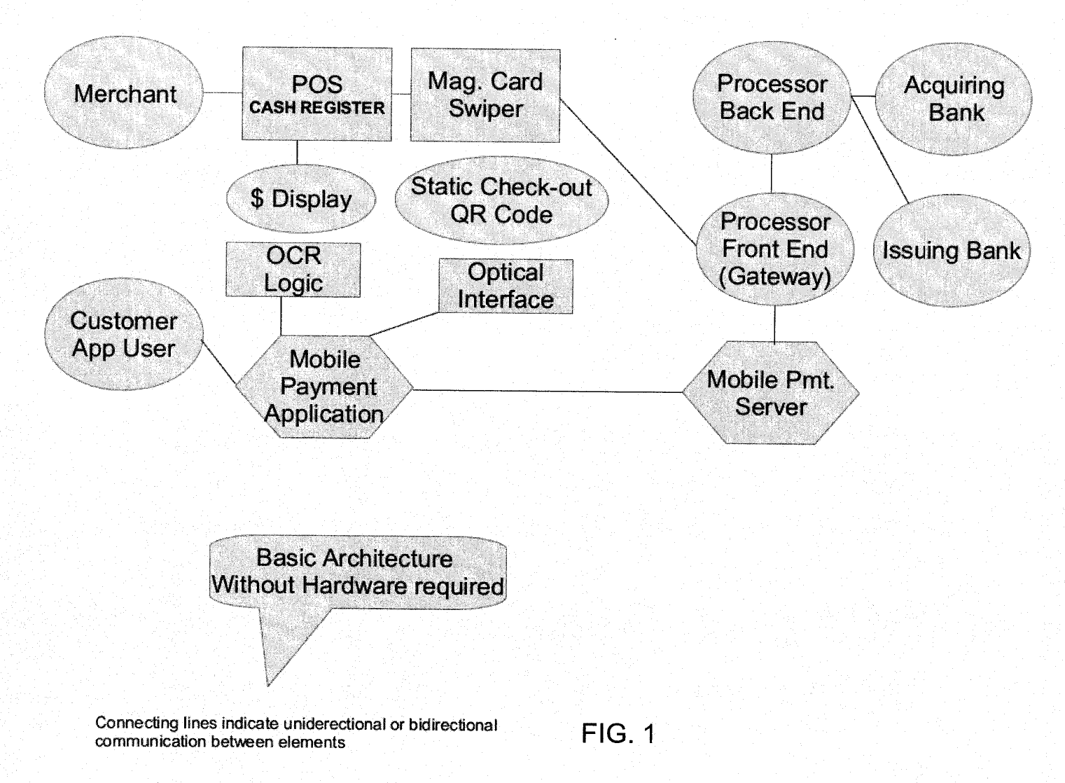

A third embodiment of the invention exists as shown in FIG. 1. by which a device is connected between the POS and the card swiper either by implementing a software solution in the POS terminal or via an additional piece of hardware connected via a RS-232 signal splitter or similar connection means known in the art. The device has a display monitor and basic computer functionality, internet connectivity and basic browser function. When the total amount due is generated by the POS terminal, that information is transmitted to the card swiper and to the device. The device has software which is activated upon receiving the total amount due from the POS Terminal and also contains the Merchant ID and Terminal ID data relative to its location. The device transmits the total amount owed, plus merchant ID and POS ID to the MPS (first data set). The MPS enters a receiving mode and is ready to receive further data. The customer scans a static matrix/QR code with a mobile payment application resident on the customer's mobile device, and is taken to the MPS. The matrix/QR code contains data including merchant ID, POS ID, processor information (second data set). Upon being scanned, this data is transmitted to the MPS. As in the first preferred embodiment disclosed above, multiple matrix/QR codes may be implemented allowing for connectivity to multiple variant payment platforms. The MPS compares the two data sets, verifying that the IDs are the same, recombining the data, retrieves the customer's financial instrument/credit card information from a PCI compliant environment, and sends a request to the processor for settlement of the transaction with this recombined data and payment information. The processor completes the transaction and sends notification to the POS terminal and/or card swiper of the transaction results. The MPS sends back transaction results to the customer's mobile payment application which is viewable by the customer.

A fourth embodiment is similar to the third embodiment disclosed above with the addition of the device being connected to a display which can generate a dynamic QR code. The device may also have one or more programmable hotkeys that each communicate with different MPS allowing the device to display dynamic matrix/QR codes compatible with variant mobile payment application/MPS combinations.

I claim:

1. A process and architecture to conduct a financial transaction between a customer and a merchant, whereby the customer uses a mobile electronic device to complete the transaction, comprising
a) the generation of a total amount due by a point of sale (POS) Terminal (a/k/a cash register or “Terminal”) which is transmitted to a magnetic card reader built into the POS Terminal, or to a card swiper unit;
b) the customer requesting to pay via mobile payment application by optically scanning with customer's mobile device a static matrix/QR code label located within close proximity to the merchant POS location;
I) said static matrix/QR code label being printed on any suitable media (paper, transparency) and placed where visible to Customer using the mobile payment application;
II) said static matrix/QR code label being either one or multiple codes displayed to the customer, each code addressing a different payment platform depending on the customer's preference provided that the individual platforms could communicate with the device either directly or via a unique MPS integration;
III) said static matrix/QR code label containing data comprising Merchant ID, POS Terminal ID, Merchant's Processor;
c) the Customer having scanned the static matrix/QR code with customer's mobile payment application, the matrix/QR code data is transmitted along with customer ID and customer's financial instrument information via the mobile payment application to the Mobile Payment Server (“MPS”) with a request to settle the transaction;
d) the Merchant swipes a card having a magnetic stripe (“Merchant Card”) through the merchant's POS Terminal's magnetic card reader or card swiper unit, said Merchant Card containing a set of data that either:
I) acts as a flag to the Processor instructing the payment gateway to route the request to settle the transaction to the MPS server in the same way as a gift card solution or other closed-loop solution implemented by the processor's payment gateway, whereby the processor's payment gateway software has been modified to recognize a specific data range to acts as a redirect of the settlement process internally; or
II) acts as a normal credit card transaction, whereby the MPS has been previously assigned a BIN number or data range recognized by the Interchange and acts effectively as an Issuing Bank;
e) MPS receives merchant ID, POS terminal ID, customer ID and customer's financial instrument information (comprising data set 1) from the mobile payment application when the customer optically scans the merchant's matrix code/QR code;
f) MPS receives merchant ID, POS terminal ID, total amount due from processor's payment gateway as a request for settlement (comprising data set 2);
g) MPS matches data set 1 and data set 2, verifying the ID information is identical, recombines the data sets upon verification, and forwards this recombined data along with the total amount due, customer ID, and customer payment method to the processor for settlement of the transaction;
h) Processor completes transaction, and transmits transaction settlement results to the MPS;
i) MPS responds to the settlement request received from the processor payment gateway with the settlement results obtained from the processor;
j) Processor responds back to the Merchant's POS Terminal unit and card swiper with the result of the transaction;
k) MPS transmits transaction results to the customer's mobile payment application.

2. A process and architecture to conduct a financial transaction between a customer and a merchant, whereby the customer uses a mobile electronic device to complete the transaction, such process comprising
a) the generation of a total amount due by a point of sale (POS) Terminal (a/k/a cash register or “Terminal”) which is transmitted to a magnetic card reader built into the POS Terminal, or to a card swiper unit;
b) customer requesting to pay by optically scanning a static matrix/QR code label displayed on a monitor located near the Merchant's POS, said scanning executed with the use of the customer's mobile payment application resident on that customer's mobile device having native optical scan recognition/OCR capabilities, scans the total amount owed from the matrix/QR code or by retrieving via the mobile payment Aaplication location information of the customer (global positioning data using native mobile device location hardware/software) which identifies the merchant ID, terminal ID, and transmitting this information to the MPS with a request of payment by mobile device;
c) the Customer prompted by the mobile payment application uses the customer's mobile device's built-in camera to take a picture of the total due displayed on the merchant's POS Terminal display screen being either dot matrix, LCD, LED or other display technology known in the art;
d) the mobile payment application transmitting the picture to the merchant's MPS;
e) the MPS server using OCR software, decodes the total amount due from the picture, matches merchant ID, terminal ID, obtained from scanned matrix/QR code or GPS database with total due acquired by customer's picture and transmits all data for settlement of the transaction to the merchant's processor;
f) MPS sending transaction result back to customer via the customer's mobile payment application. Merchant has result available through the Processor.
g) Merchant may access transaction results by the POS Terminal by swiping a Merchant Card through the POS Terminal's magnetic card reader or card swiper unit, said Merchant Card containing a set of data that either:
I) acts as a flag to the processor instructing the payment gateway to route the request to settle the transaction to the MPS server in the same way as a gift card solution or other closed-loop solution is implemented by the processor's payment gateway, whereby the processor's payment gateway software has been modified to recognize a specific data range to acts as a redirect of the settlement process internally; or
II) acts as a normal credit card transaction, whereby the MPS has been previously assigned a BIN number or data range recognized by the Interchange and acts effectively as an Issuing Bank;
h) MPS receives merchant ID, terminal ID, customer ID and customer's financial instrument information (comprising data set 1) from the mobile payment application when the customer optically scans the merchant's matrix code/QR code;
i) MPS receives merchant ID, terminal ID, total amount due from processor's payment gateway as a request for settlement (comprising data set 2);
j) MPS matches data set 1 and data set 2, verifying the ID information is identical, recombines the data sets upon verification, and forwards this recombined data along with the total amount due, customer ID, and customer payment method to the processor for settlement of the transaction;
k) Processor completes transaction, and transmits transaction settlement results to the MPS;
l) MPS responds to the settlement request received from the processor payment gateway with the settlement results obtained from the processor;
m) Processor responds back to the POS Terminal and card swiper with the result of the transaction;
n) MPS transmits transaction results to the customer's mobile payment application.

3. A process and architecture to conduct a financial transaction between a customer and a merchant, whereby the customer uses a mobile electronic device to complete the transaction, such process comprising
a) the generation of a total amount due by a point of sale (POS) Terminal (e.g. cash register) which is transmitted to a magnetic card reader built into the POS Terminal, or to a card swiper unit, and a device, said device being either
I) a software based solution resident int the POS Terminal; or
II) a hardware based solution connected to the POS Terminal via RS-232 connection or similar connection means generally known in the art, said device having a display monitor and basic computer functionality, internet connectivity and basic browser function, and further having software activated upon receiving the total amount due from the POS Terminal which also contains the Merchant ID and Terminal ID data relative to its location;
b) Upon activation of said device, its software protocol forwards the total amount due, plus merchant ID and terminal ID data to a MPS via said device's internet connection;
c) MPS, after receiving said data, enters into a receiving mode awaiting a customer to claim the transaction with matching merchant ID and terminal ID;
d) Customer initiates requests to claim the transaction and make payment using a mobile payment application tied to the MPS, said mobile payment application residing on the customer's mobile device, by optically scanning a static matrix/QR code with the use of the mobile payment application and the mobile device's camera and optical scan functions;
i) said static matrix/QR code being either one or multiple codes displayed to the customer, each code addressing a different payment platform depending on the customer's preference provided that the individual platforms could communicate with the device either directly or via a unique MPS integration;
e) Said static matrix/QR code being scanned allows the mobile payment application to identify the merchant ID, terminal ID, merchant's processor information, and transmits this data along with customer ID and customer's financial instrument data which is either stored or is entered into the customer's mobile device, to the MPS;
f) The MPS then matching the data received by the device connected to the POS Terminal with the data received by the customer's mobile payment application;
g) The MPS then retrieving credit card information from a database, and sending a request to the Merchant's Processor that includes the customer ID and customer's financial instrument data, merchant ID, terminal ID, and the total amount due;
h) The Processor then receiving request for payment with reintegrated data from MPS and contacts customer's issuing bank to complete transaction, receiving approval and credit for the transaction, and sending funds to acquiring bank less transaction fees to credit the Merchant, thereby generating transaction result data;
i) Processor sending transaction result data to Merchant via an internet-based application or through their payment gateway and via the MPS;
j) the MPS then sending transaction result data back to the POS Terminal which, by mimicking the card swiper signal response to a successful transaction result, displays the transaction result data and causes the POS Terminal system to respond as if it received a successful transaction result from the card swiper unit;
k) the MPS further sending transaction result data to the customer's mobile application which displays said acknowledgment of payment.

4. A process and architecture to conduct a financial transaction between a customer and a merchant, whereby the customer uses a mobile electronic device to complete the transaction, such process comprising
a) the generation of a total amount due by a point of sale (POS) Terminal (a/k/a cash register or “Terminal”) which is transmitted to a magnetic card reader built into the POS Terminal, or to a card swiper unit and a device via RS-232 connection or similar connection means generally known in the art, said device being a computer with basic computer components and functionality and internet connectivity;
i) said device further having software activated upon receiving the total amount due from the POS Terminal which also contains the merchant ID and terminal ID data relative to its location;
ii) said device further having physical programmable hotkeys that each communicate with different MPS allowing the device to display dynamic matrix/QR codes compatible with variant mobile payment application/MPS combinations;
b) Upon activation of said device, its software protocol forwards the total amount due, plus merchant ID and terminal ID data to a MPS via said device's internet connection;
c) MPS, after receiving said data, enters into a receiving mode awaiting a customer to claim the transaction with matching merchant ID and terminal ID;
d) Customer initiates requests to claim the transaction and make payment using a mobile payment application tied to the MPS, said mobile payment application residing on the customer's mobile device, by optically scanning a dynamic matrix/QR code with the use of the mobile payment application and the mobile device's camera and optical scan functions;
e) Said dynamic matrix/QR code being scanned allows the mobile payment application to identify the merchant ID, terminal ID, merchant's processor, and transmits this data along with customer ID and customer's financial instrument data that is either stored or is entered into the customer's mobile device, to the MPS;
f) The MPS then matching the data received by the device connected to the POS Terminal with the data received by the customer's mobile payment application;
g) The MPS then retrieving credit card information from a database, and sending a request to the merchant's processor that includes the customer ID and customer's financial instrument data, merchant ID, terminal ID, and the total amount due;
h) The Processor then receiving request for payment with reintegrated data from MPS and contacts customer's issuing bank to complete transaction, receiving approval and credit for the transaction, and sending funds to acquiring bank less transaction fees to credit the merchant, thereby generating transaction result data;
i) Processor sending transaction result data to merchant via an internet-based application or through their payment gateway and via the MPS;
j) the MPS then sending transaction result data back to the POS Terminal which, by mimicking the card swiper signal response to a successful transaction result, displays the transaction result data and causes the POS Terminal system to respond as if it received a successful transaction result from the card swiper unit;
k) the MPS further sending transaction result data to the customer's mobile application which displays said acknowledgment of payment.
